(19) United States
(12) Patent Application Publication
(10) Pub. No.: US 2007/0217661 A1
(43) Pub. Date: Sep. 20, 2007

(54) Authentication system and method

(76) Inventor: George Massoud, San Jose, CA (US)

Correspondence Address: PRITZKAU PATENT GROUP, LLC, 993 GAPTER ROAD, BOULDER, CO, 80303, US

(21) Appl. No.: 11/367,883

(22) Filed: Mar. 3, 2006

(51) Int. Cl. G06K 9/00

(52) U.S. Cl. 382/119

(57) ABSTRACT

An exemplary embodiment providing one or more improvements includes an authentication system which allows an article to be authenticated using an article serial number connected with the article and a self-authenticating document having a serial number that is associated with the article serial number. Access to a database containing the association is provided and the article is authenticated by self authenticating the document and accessing the database to determine the association.

The present device and method relates generally to the field of authenticating an article to ensure that the article is genuine and not a reproduction or imitation, and more particularly, to a device and method which provides for an article to be authenticated in association with a self-authenticating document.

### BACKGROUND

Articles or products produced by some manufacturers are more desirable than similar products produced by other manufacturers. One of the reasons for this desirability is that some manufacturers have developed a reputation for producing high quality goods. Another reason that makes some products more desirable is based on it being fashionable to have a product with a particular brand name. In many instances the desirable products are relatively expensive due to the increased cost of manufacturing a product with high quality and/or promotional costs to make the product desirable. Examples of these types of desirable products are found in many different areas including jewelry, personal accessories, sporting goods and original works of art, among products in other areas.

Other articles are desirable because they are memorabilia. The desirability of memorabilia is often related to a connection with a famous person such as a professional athlete. The memorabilia can be a ball or other object that is signed by the athlete or famous person. Other objects or collectable items can also be desirable as memorabilia articles.

Because the popularity and expense of these desirable articles, a significant financial incentive exists for unethical people to produce cheap counterfeit copies or forgeries of the articles. The counterfeit articles are made to appear like the authentic products but are usually of significantly lower quality than the authentic articles or in the case of memorabilia, do not have the genuine signature or other feature which makes the memorabilia desirable. The counterfeit articles can also have the same trademarked name or a name that resembles the trademarked named on the product to fool consumers into believing that they are buying an authentic product. The counterfeit copies can be sold for a lower price than the authentic article to induce unsuspecting consumers into buying the copy when they may not be able to afford the authentic article.

Many of the counterfeit articles produced are so close in appearance to the genuine article that the normal consumer is unable to differentiate the counterfeit from the genuine article. Although experts can usually determine a counterfeit from a genuine article, it is not always convenient or cost effective to bring the article to an expert. Because of this, there has developed a need for the ability to inexpensively authenticate genuine articles.

One prior approach taken for authenticating an item involves a system in which an image bearing medium or hologram sticker with a unique code number is affixed to the item with a tamper proof adhesive. A certificate of authenticity is also provided which includes another image bearing medium or hologram sticker that is printed with a matching code number. The unique code numbers are listed along with a description of the related item to allow a purchaser to register the item or to allow a subsequent purchaser to check the listing to determine if the item has been registered as authentic. A registration hotline is provided to allow the authenticity to be verified when the article is sold or otherwise transferred.

This system is unnecessarily complex and burdensome because to ensure that the item is not forged, the manufacturer must create their own stickers and certificates of authenticity that cannot be forged. This involves creating special features in the stickers and certificate document that cannot be duplicated by a copy manufacturer or forger. To stay ahead of the forgers the manufacturer must be able to produce stickers and certificate documents that others cannot, therefore not only must the manufacturer be in the business of producing a desirable product, they must also be on the leading edge of producing unique and un-forgeable documents. In addition, once the special stickers and certificate document are made, the manufacturer must also inform the consumer or retailer on how to determine if the sticker and certificate document are authentic.

Another approach taken for verifying the authenticity of an item involves having a representative of a verification company present when the item is created and presented to the consumer. This system then involves issuing a voucher to the consumer with an identifying code number, affixing the same code number to the item and providing a certificate of authenticity with a different code number and the identity of the owner. The identification of the owner and the details on where and when the item was obtained is then entered and kept in a database. This system is complex and time consuming as well requiring the expense of having a representative of the verification company present during the creation and transfer of the item to the consumer. In addition this system also requires that the identity of the current owner be kept in a database which is burdensome and creates an unnecessary additional cost.

The foregoing examples of the related art and limitations related therewith are intended to be illustrative and not exclusive. Other limitations of the related art will become apparent to those of skill in the art upon reading of the specification and a study of the drawings.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In general, an authentication system and method is described in which an article is verifiable as authentic in association with a self-authenticating document and access to a database.

One embodiment, by way of example, is a method for producing the article which provides for subsequent verification of authenticity of the article. In this embodiment the self authenticating document is a note of a currency issued by a government which has a note serial number that is unique for the currency. The note has self authenticating features which are examinable to allow the note to be self authenticated as genuine and issued by the government. The article is produced with an article serial number. An association between the article serial number and the note serial number is established and access to the association is provided. Verification of the authenticity of the article involves verification of the association in conjunction with self authenticating the note.

Another exemplary embodiment involves a combination for authenticating an article subsequent to the article being produced. This embodiment includes a note of a selected denomination of a government issued currency which has authenticating features that allow the currency to be self authenticated. The note includes a note serial number and the article has an article serial number that is associated with the note serial number. The association can be contained in a database so that the authenticity of the article is determinable by self authenticating the note and confirming the association by accessing the database.

A further exemplary embodiment involves a system for authenticating an article with a database. The database includes a serial number of an article and a serial number of a note of a government issued currency. The note includes authenticating features which allow the currency to be self authenticated. The article serial number is associated with the note serial number in the database for authenticating the article by self authenticating the note and confirming the association by accessing the database.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is an illustration of an authentication system for authenticating an article with an authentication document along with an accessible database, where the article shown is a manufactured article.

FIG. 2 is an illustration of another authenticable article.

FIG. 3 is a flow chart illustrating a process of creating the authentication system for use in authenticating the article of FIG. 1 or 2.

FIG. 4 is a flow chart illustrating a method for authenticating the article shown in FIG. 1 or 2 with the authentication system.

### DETAILED DESCRIPTION

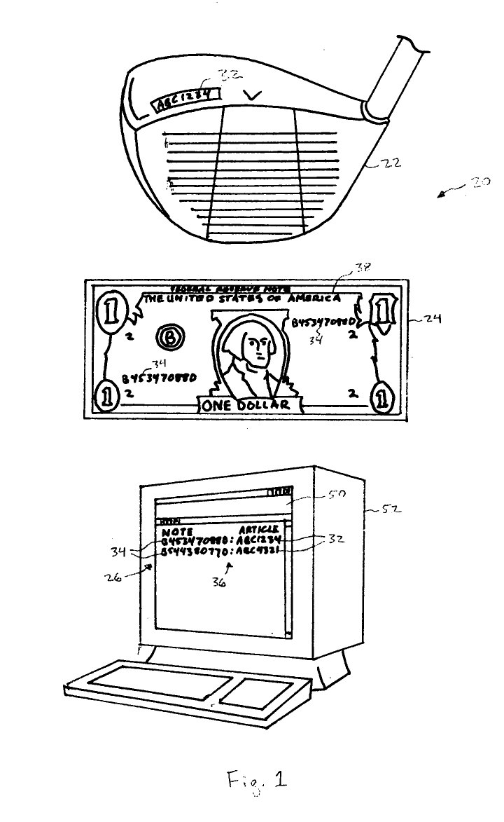

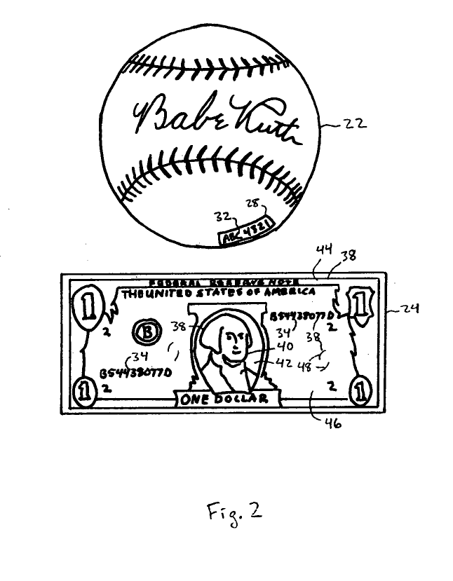

An authentication system 20 is shown in FIG. 1 for authenticating an article 22 using a self-authenticating document such as note 24 and an accessible database 26. Article 22 can be manufactured such as the golf club shown in FIG. 1 or memorabilia such as the Babe Ruth signed baseball shown in FIG. 2. An article serial number 32 is attached to article 22 as part of a label 28 or is otherwise permanently part of article 22, and a note serial number 34 (FIGS. 1 and 2) is printed on note 24. Database 26 contains an association 36 between article serial number 32 and note serial number 34. Notes 24 shown in FIGS. 1 and 2 are United States one-dollar bills which have self authenticating features 38 (FIG. 2) that can be examined to determine whether or not note 24 is genuine United States issued currency printed by the United States government.

Authentication system 20 (FIG. 1) allows article 22 to be authenticated subsequent to an original determination authenticity. Authenticating article 22 involves self-authenticating note 24 to determine that note 24 is genuine by examination of one or more of self authenticating features 38; determining article serial number 32 and note serial number 34; and accessing database 26 to determine if database 26 contains association 36 between article serial number 32 and note serial number 34.

The original determination of authenticity is done by an authenticating party (not shown). When article 22 is manufactured, the authenticating party is typically the manufacturer who makes the original determination of authenticity by producing article 22. In another instance, the authenticating party can be an auctioneer or other person who is a reputable authenticator of the type of article to be authenticated. When article 22 is memorabilia, the authenticating party making the original determination of authenticity can be an expert in authenticating memorabilia by examination of article 22 or by other means, or a witness to the creation of article 22, or other person or company who can guarantee that the memorabilia is authentic. As an example, the authenticating party can make the original determination of authenticity of memorabilia by witnessing a sports celebrity signing a ball.

Typically after the original determination that article 22 is authentic, the authenticating party or other party who has knowledge of the authenticity of article 22 associates article 22 with note 24. Article serial number 32 can also be attached to article 22 at this time. Article serial number 32 can be the same as note serial number 34 or article serial number 32 and note serial number 34 can be different. After associating article 22 with note 24, association 36 is stored in database 26. Access to association 36 on database 26 is provided by the authenticating party or other party who takes responsibility for ensuring that database 26 only contains associations 36 with authentic articles 22.

Notes 24 shown in FIGS. 1 and 2 are one example of an authentication document that can be used in authentication system 20. Other United States currency denominations and series can also be used as the authentication document as well as currencies of other countries which have at least one self-authenticating feature and a serial number.

Each genuine note 24 is unique in that each note 24 has a note serial number that is different from the note serial number of every other note 24. When database 26 lists note serial number 34 of a genuine note 24, that genuine note 24 is then known to be the authentication document for an article 22 that was originally authenticated by the authenticating party. That genuine note 24 is also known to be associated with one particular genuine article 22 having the article serial number 32 in association 36 in database 26. Therefore, possession of genuine note 24 that is listed on database 26 is proof that the possessor of genuine listed note 24 is in a chain of possession that includes possession of authentic article 22. A person in possession of genuine note 24 and article 22 with associated serial numbers 32 and 34 on database 26 has proof of authenticity of article 22 which is directly tied to the original authentication of article 22.

One reason why authentication system 20 is unique is that anyone making a counterfeit article would also have to make a corresponding counterfeit note and would therefore be subject to criminal prosecution from the government that issues the genuine note 24. Criminal prosecution for counterfeiting currency is a strong deterrent against counterfeiting note 24. Moreover, because of self-authenticating features 38, counterfeiting currency is also very difficult.

Self-authenticating note 24 such the United States one-dollar bill is authenticable by examination of authenticating features 38 of note 24. Examples of some of self authenticating features 38 of note 24 are shown in FIG. 2. In genuine note 24, a portrait 40 appears lifelike and stands out from a background 42 surrounding portrait 40. In a counterfeit note, portrait 40 is often lifeless and flat and details merge into background 42. In genuine note 24, a border 44 has fine lines which are clear and unbroken while in the counterfeit the lines will often be blurred and indistinct. Note serial number 34 in genuine note 24 has a distinct style and the individual numbers and/or letters are evenly spaced. The note serial number in the counterfeit may have numbers that are not uniformly spaced or aligned. Genuine note 24 has paper 46 with tiny red and blue fibers 48 embedded throughout. Counterfeit paper typically has red and blue lines printed on the paper to simulate fibers 48. It is illegal under United States law to reproduce the paper used in United States currency.

Because note 24 is commonly used in trade, self-authenticating features 38 of genuine note 24 are well known. This allows note 24 to be used as the self-authentication document without the manufacturer having to get involved in teaching consumers how to authenticate note 24. Many people, including most bank personnel, have the ability to authenticate government currency. Another advantage in using government issued currency as the self-authentication document is that it is easy and relatively inexpensive to obtain compared with the cost that the manufacturer would incur to develop and produce their own self-authentication documents.

Access to database 26 is provided in order for someone to determine that article serial number 32 is associated with note serial number 34. An internet website 50 is shown in FIG. 1 as an example of one way to provide access to database 26. Website 50 is accessible to the general public, such as through a computer 52, so that anyone who has access to the internet can access association 36 on database 26. In addition or as an alternative to website 50, access to database 26 can be provided through a telephone service, by mail or by another method of communications.

Database 26 can also contain other information about article 22, note 24 or other useful information relating to the authenticity of article 22 or note 24. For instance, database 26 could contain the name of the person who originally authenticated the article 22. The database could also contain a description of article 22 and/or note 24.

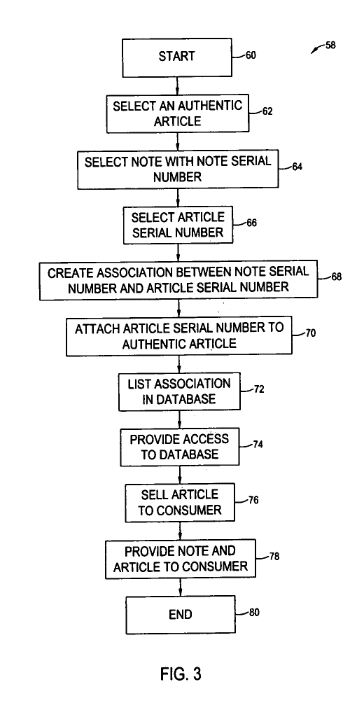

An exemplary process 58 of producing article 22 that takes advantage of authenticating system 20 is shown in FIG. 3, and may likewise be applied to an item of memorabilia. Process 58 begins at a start 60 from which the process 58 proceeds to 62 where an originally authenticated article 22 is selected. Following the selection at 62, process 58 proceeds to 64 where note 24 having note serial number 34 is selected. At 66, process 58 continues with the selection of article serial number 32. Article serial number 32 can be the same as note serial number 34 or different. Process 58 continues to 68 where association 36 is created between note serial number 34 and article serial number 32. If note serial number 34 and article serial number 32 are the same number, then association 36 is not needed since only the shared number must be kept track of. Process 58 continues at 70 where article serial number 32 is attached or otherwise affixed to article 22. In some cases article serial number 32 can be printed on a label that is affixed to article 22 with adhesive, in other cases it may be more appropriate to etch article serial number 32 onto article 22. In still other instances it may be better to cast article 22 with article serial number 32 as part of article 22. Many different methods or techniques for affixing article serial number 32 to article 22 may be used as long as article serial number 32 is difficult to remove from article 22.

Following 70, process 58 proceeds to 72 where association 36 of note serial number 34 and article serial number 32 are listed in database 26. Access to database 26 is provided at 74 following the listing at 72. Association 36 ties the authenticity of article 22 with the authenticity of note 24. Process 58 continues at 76 where article 22 is sold to a consumer. Article 22 and note 24 may be shipped to a retailer together or separately before or after being sold to the consumer. Article 22 and note 24 may also be shipped together or separately directly to the consumer before or after being sold to the consumer. Shipping article 22 and note 24 separately has the benefit of preventing someone who has stolen article 22 without note 24 from being able to authenticate article 22. Either separately or together, article 22 and note 24 are provided to the consumer at 78 of process 58. Process 58 ends at 80 where the consumer has received an article 22 that can be authenticated at any time in the future by using note 24 and accessing database 26.

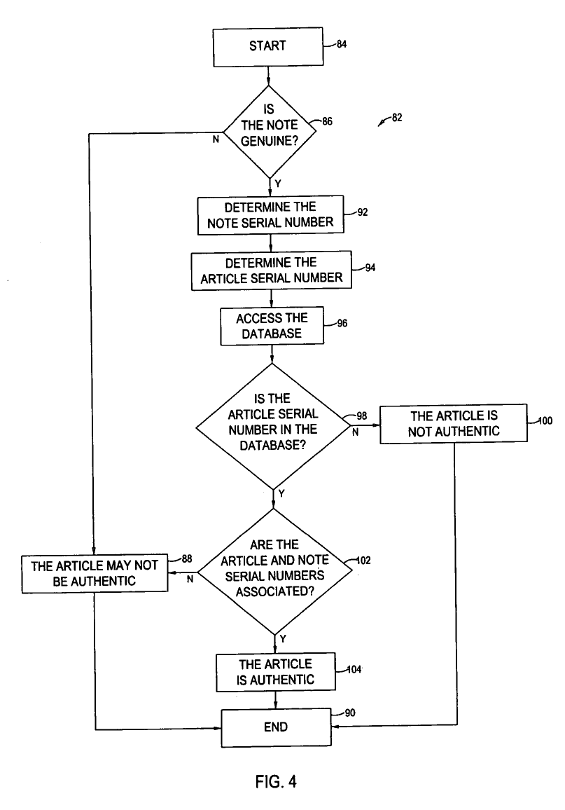

At any time subsequent to the purchase, the consumer or a subsequent purchaser can authenticate article 22 by self-authenticating note 24 and accessing database 26 to show association 36 of article serial number 32 and note serial number 34. A method of authentication 82 of article 22 using authentication system 20 is shown in FIG. 4. Method 82 begins at a start 84 after which the method proceeds to a determination 86 where a determination is made as to whether of not note 24 is authentic. The determination at 86 is made by self authenticating note 24 through examination of one or more of self authenticating features 38 to determine if note 24 is genuine. If the determination at 86 is that note 24 is not authentic, then method 82 proceeds to 88 where the conclusion is made that article 22 may or may not be authentic. Article 22 may be authentic even if note 24 is not genuine, although it may be difficult or impossible to prove the authenticity of article 22 if note 24 is not genuine and it is likely that the article is not authentic if a seller produces a note that is counterfeit. Following the conclusion at 88, method 82 ends at 90.

If the determination at 86 is that note 24 is genuine, then method 82 proceeds to 92 where note serial number 34 is determined. The method then proceeds to 94 where article serial number 32 is determined by examination of article 22. After article serial number 32 is determined at 94, method 82 proceeds to 96 where database 26 is accessed. After accessing database 26, method 82 proceeds to the determination at 98.

At the determination 98, a determination is made as to whether database 26 contains article serial number 32. If the determination is that database 26 does not contain article serial number 32, then method 82 proceeds to 100 where a conclusion is made that article 22 is not authentic since authentic articles 22 have article serial numbers 32 that are listed in database 26. Following the conclusion at 100, method 82 proceeds to the end at 90.

If the determination at 98 is that article serial number 32 is listed in database 26 then method 82 proceeds to 102. At 102 it is determined whether or not database 26 contains association 36 between article serial number 32, determined to be in the database at 98, and note serial number 34 from note 24 that is determined to be genuine at 86. If association 36 is not in database 26, then the method proceeds to 88 where the conclusion is drawn that article 22 may or may not be authentic. The article may be authentic even though association 36 is not in database 26. For instance if article serial number 32 is in database 26, but is associated with another note serial number 34, then article 22 may be authentic but will not be authenticable by method 82. From 88, method 82 ends at 90. If the determination at 102 is that association 36 is in database 26, then method 82 proceeds to 104 where article 22 is concluded to be authentic. The method ends at 90 following the determination of authenticity at 104.

Several advantages are gained by using authentication system 20. For instance, authentication system 20 does no require keeping an updated list of current owners of the article. Once association 36 is entered into database 26, association 36 does not have to be changed. This makes the database inexpensive to create and maintain compared with other authentication approaches which attempt to keep track of the current owner of an article.

Another advantage gained by authentication system 20 is that authentication system 20 does not require the manufacturer or supplier of article 22 to create and maintain an authentication document that is difficult to counterfeit. Therefore, no expense or time is wasted in creating or updating the authentication document to stay ahead of counterfeiters. Moreover, by using note 24 or other currency as the authentication document, there is a strong disincentive to counterfeiting the authentication document over and above the possible legal issues raised by the manufacturer or supplier of article 22 against a counterfeiter.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method for use in subsequent verification of authenticity of an article, said method comprising:
designating an article serial number for use with the article;
providing a note of a selected denomination of a currency issued by a government, the note having a note serial number and self authenticating features which are examinable to allow for a determination that the note is genuine and was issued by the government;
establishing an association between the article serial number and the note serial number; and
providing access to the association to allow for verification of authenticity of the article based on the association in conjunction with self authenticating the note.

2. A method as defined in claim 1 wherein designating includes duplicating the note serial number as the article serial number.

3. A method as defined in claim 1 wherein said establishing is performed after said designation of the article serial number.

4. A method as defined in claim 1 wherein designating includes generating an article serial number that is unique.

5. A method as defined in claim 1 wherein the note provided is a United States one dollar bill.

6. A method as defined in claim 1 wherein the article is manufactured by a particular producer.

7. A method as defined in claim 1 wherein the article is a memorabilia article and the article is designated by affixing the article serial number to the memorabilia article.

8. A method as defined in claim 1 wherein access to the association is provided by accessing a database.

9. A method as defined in claim 1 wherein access to the association is provided through the internet.

10. A method as defined in claim 1 wherein access to the association is provided by telephone.

11. A method as defined in claim 1 wherein access to the association is provided by mail.

12. A combination for authenticating an article subsequent to the article being produced, said combination comprising:
a note of a selected denomination of a government issued currency having authenticating features which allow the currency to be self authenticated and having a note serial number; and
the article having an article serial number that is associated with the note serial number, wherein a database can contain the association, and the authenticity of the article is determinable by self authenticating the note and confirming the association by accessing the database.

13. A combination as defined in claim 12 wherein the article serial number is the same as the note serial number.

14. A combination as defined in claim 12 wherein the article serial number is different from any other serial number of a similar article.

15. A combination as defined in claim 12 wherein the note is a United States one dollar bill.

16. A combination as defined in claim 12 wherein the self authenticating features include at least one characteristic of a paper that is used as part of the note.

17. A combination as defined in claim 12 wherein the self authenticating features include at least one printed attribute of the note.

18. In a system for authenticating an article, a database comprising:
a serial number of the article; and
a serial number of a note of a selected denomination of a government issued currency having authenticating features which allow the currency to be self authenticated, wherein the article serial number is associated with the note serial number in the database for authenticating the article by self authenticating the note and confirming the association by accessing the database.

19. A database as defined in claim 18 wherein the database is accessed through the internet.

20. A database as defined in claim 18 wherein the database is accessed by the telephone.

21. A database as defined in claim 18 wherein the article serial number is the same as the note serial number.
